(19) United States
(12) Patent Application Publication
(10) Pub. No.: US 2012/0228092 A1
(43) Pub. Date: Sep. 13, 2012

(54) FLEXIBLE TRACK AND SYSTEM INCORPORATING SAME

(76) Inventor: Edwin A. Erlbacher, II, Dallas, TX (US)

(21) Appl. No.: 13/511,297

(22) PCT Filed: Nov. 23, 2009
(86) PCT No.: PCT/US09/65495

§ 371 Date: May 22, 2012

(51) Int. Cl. B65G 21/16

(52) U.S. Cl. 198/837

(57) ABSTRACT

A flexible track includes a base configured to be generally flexible along a neutral bending axis of the flexible track and generally rigid in a torsional direction, the torsional direction being generally rotated about the neutral bending axis. A drive chain is mounted to the base and aligned generally with the neutral bending axis. A system includes a flexible track and an apparatus. The flexible track includes a base configured to be generally flexible along the neutral bending axis of the flexible track and generally rigid in a torsional direction, the torsional direction being generally rotated about the neutral bending axis. The flexible track further includes a drive chain mounted to the base aligned generally with the neutral bending axis. The apparatus includes a drive sprocket engaged with the drive chain and a motor and gear box operably associated with the drive sprocket.

### TECHNICAL FIELD

The present invention relates to a flexible track and a system incorporating the flexible track in which an apparatus is configured to travel along the flexible track.

### DESCRIPTION OF THE PRIOR ART

While it is commonplace to perform operations, such as manufacturing-related operations, on smaller workpieces having sizes that fit within working envelopes of stationary machine tools, performing such operations on very large structures is problematic. Because conventional machine tools have fixed work envelopes, many large structures or workpieces must be machined using hand-operated tools. Such manual operations are fraught with challenges and opportunities for damage to the workpiece and injury to personnel performing the operations.

One example of such an operation on a very large structure is the facing of weldments, such as weldments that connect sections of ship hulls. To manufacture such a ship hull, adjacent, curved steel plates are butt-welded, leaving a portion of weldment extending beyond the outer surface of the hull. It is desirable in many situations to remove this excess weldment to reduce surface drag, increase coating adhesion, reduce radar signature, and the like. Conventionally, the excess weldment is removed using hand-operated tools to a consistent, predetermined surface slightly above the surrounding parent material, within predetermined dimensional tolerances. These manual operations require significant amounts of labor, time, and skill to achieve the desired dimensional tolerances without damaging adjacent parent material. Hand grinding can also be very injurious to the workforce, often resulting in frequent reportable ergonomic injuries, fatigue-related injuries, and eye injuries. Personnel involved in such manual operations are often also exposed to airborne particulate and gaseous emissions, as well as exposure to extended periods of grinding noise at high decibel levels. Moreover, manual grinding processes must be controlled to limit heat input to the weldments and to limit potential distortion, particularly in thinner plates.

Accordingly, while there are ways of performing operations on very large workpieces and structures well known in the art, considerable shortcomings remain.

### BRIEF DESCRIPTION OF THE DRAWINGS

The novel features believed characteristic of the invention are set forth in the appended claims. However, the invention itself, as well as, a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 is a perspective view of an illustrative embodiment of a flexible track;

FIG. 2 is top, plan view of the flexible track of FIG. 1;

FIG. 3 is bottom, plan view of the flexible track of FIG. 1;

FIG. 4 is a side, elevational view of the flexible track of FIG. 1;

FIGS. 5 and 6 are end, elevational views of the flexible track of FIG. 1;

FIG. 7 is a top, plan view of an illustrative embodiment of a drive chain of the flexible track of FIG. 1;

FIG. 8 is a side, elevational view of the drive chain of FIG. 7;

FIG. 9 is an enlarged, perspective view of a portion of the flexible track of FIG. 1;

FIG. 10 is a partially exploded, perspective view illustrating attachment of adjacent flexible tracks;

FIGS. 11-13 are perspective views of a system incorporating the flexible track of FIG. 1;

FIG. 14 is an enlarged view of a portion of the view of FIG. 13;

FIG. 15 is a perspective view of the system of FIG. 11 illustrating a replaceable head thereof;

FIGS. 16A and 16B are stylized views depicting exemplary cutter configurations;

FIG. 17 is a perspective view of the system of FIG. 11 including a control console;

FIGS. 18-21 are views illustrating various operational positions of the system of FIG. 11;

FIG. 22 is a perspective view depicting an illustrative embodiment of an implementation of the flexible track of FIG. 1; and

FIG. 23 is a stylized, side, elevational view of a sprocket and front guide wheels of an apparatus used with the flexible track of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

Description of the Preferred Embodiment

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The present invention represents a flexible track and a system incorporating the flexible track in which an apparatus is configured to engage with and travel along the flexible track. The flexible track comprises a base configured to be generally flexible along a first axis and generally rigid along a second axis. The flexible track further comprises a drive chain mounted to the base, such that the drive chain is aligned generally with the first axis. The system comprises the flexible track and an apparatus comprising a drive sprocket. The drive sprocket is engaged with the drive chain, such that the apparatus rotates the drive sprocket to move the apparatus along the track. The present invention contemplates many various types of apparatuses that may be incorporated into the system, including, but not limited to, apparatuses configured for weld facing, weld joint preparation, weld joint gouging, beveling, inspection, welding, drilling, sanding, and the like. The system is particularly useful in performing processes that involve high reaction forces. The present flexible track is useful in operations, and particularly in machining operations, performed on large structures, such that the flexible track is mounted to the large structure while such operations are being performed.

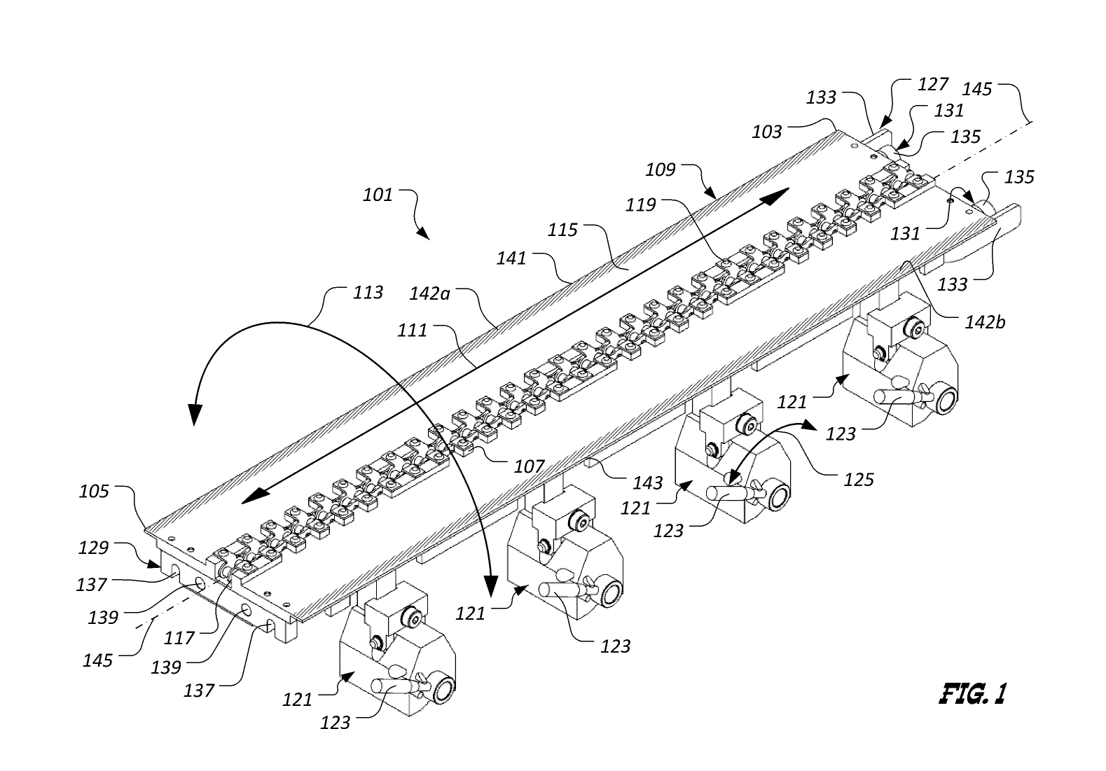

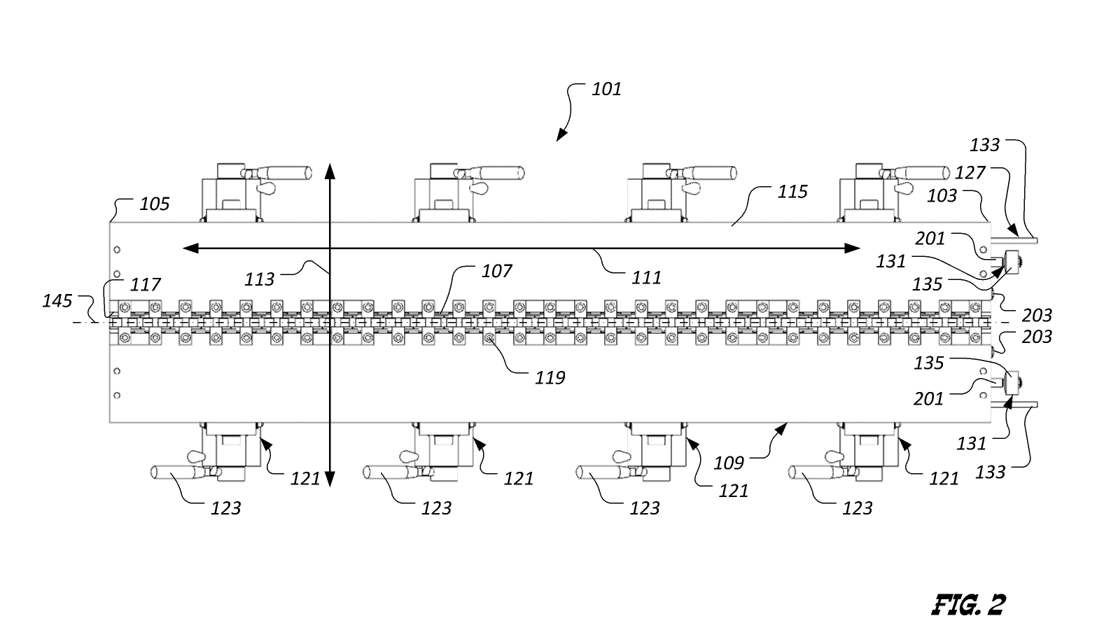

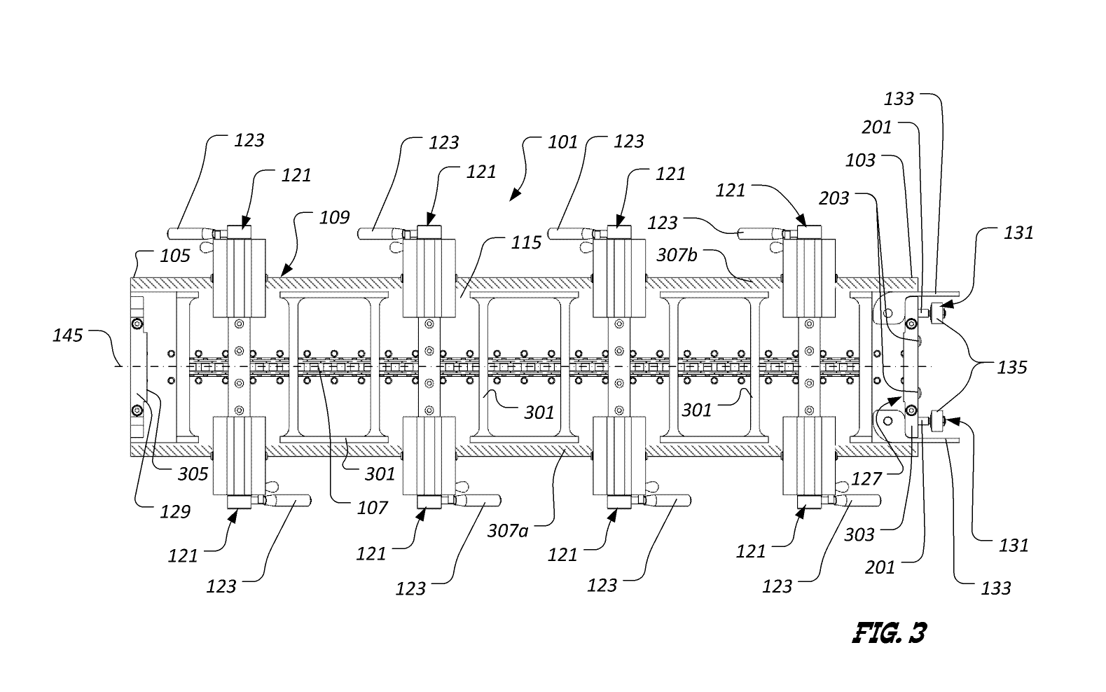

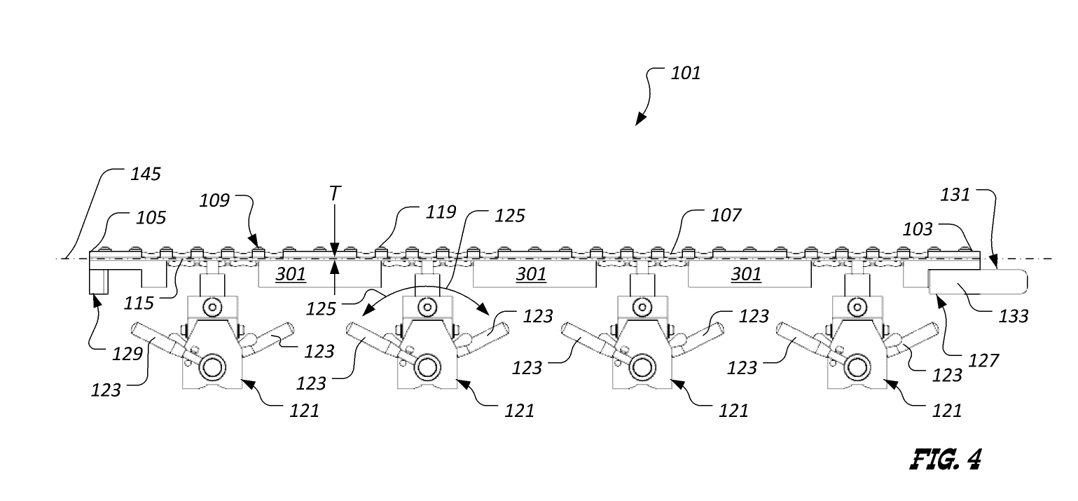

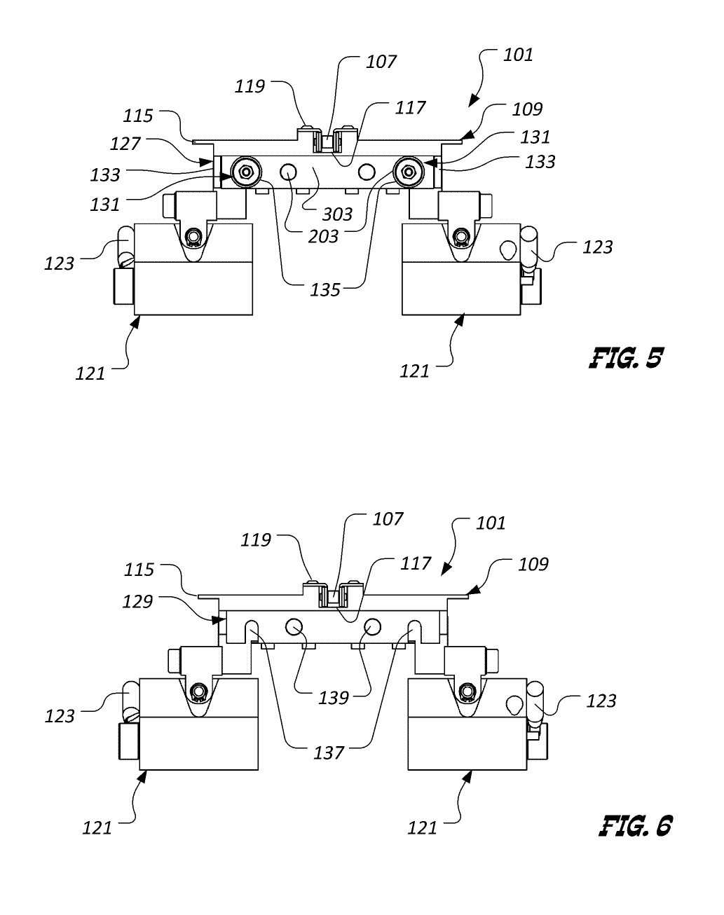

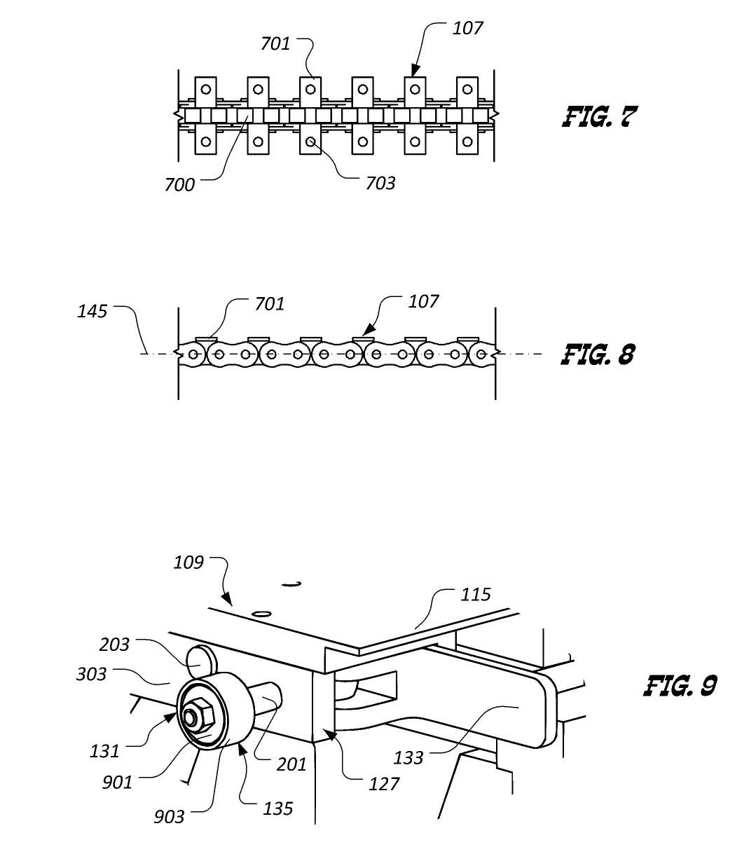

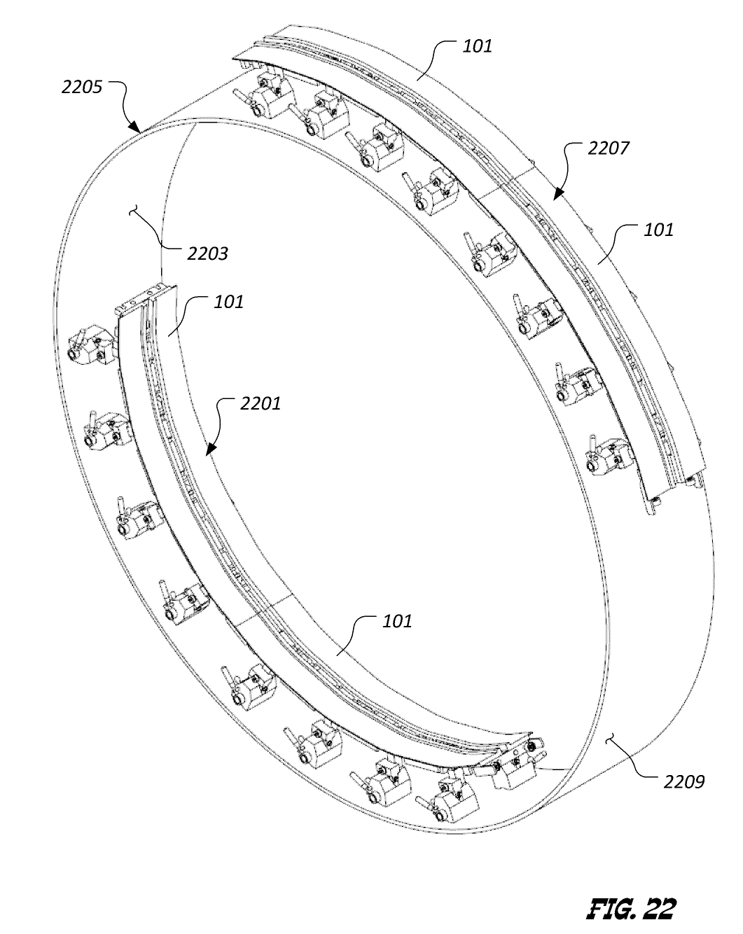

FIGS. 1-6 depict various views of an illustrative embodiment of a flexible track 101. FIG. 1 depicts a perspective view of flexible track 101. FIGS. 2 and 3 depict top and bottom plan views, respectively, of flexible track 101. FIG. 4 depicts a side, elevational view of flexible track 101. FIG. 5 depicts an end, elevational view of a cam end 103 of flexible track 101. FIG. 6 depicts an end elevational view of a slotted end 105 of flexible track 101. Additionally, FIGS. 7 and 8 depict a top, plan view and a side, elevational view, respectively, of a drive chain 107 of flexible track 101. Flexible track 101 comprises a base 109 that is generally flexible in a longitudinal direction represented by a double-headed arrow 111, i.e., corresponding to directions generally along a neutral bending axis 145, and that is generally rigid in a torsional direction generally rotated about neutral bending axis 145 (shown in FIGS. 1, 4, and 8), as represented by a double-headed arrow 113. This configuration allows flexible track 101 to generally conform to a curved surface, for example as discussed herein with regard to FIG. 22, while allowing large forces to be applied to the work surface being processed. For example, if flexible track 101 is used in a system that machines a workpiece, the rigidity of flexible track 101 in torsional direction 113 keeps the machining cutter in contact with the workpiece. As best shown in FIG. 3, base 109 comprises a plurality of stiffening elements 301 extending from a guide plate 115. Stiffening elements 301 provide torsional rigidity to flexible track 101. While stiffening elements 301 are illustrated in the drawings as having a particular, box-like configuration, the scope of the present invention is not so limited. The particular configurations of stiffening elements 301 are implementation specific, as different degrees of torsional rigidity are desirable depending upon the particular implementation of flexible track 101. Adjacent stiffening elements 301 are spaced apart from one another, thus allowing flexible track 101 to be flexible in longitudinal direction 111. Members, such as magnetic clamps 121 (discussed in greater detail herein), used to attach flexible track to a structure are located within the spaces between stiffening elements 301. In one embodiment, guide plate 115 has a thickness T (shown in FIG. 4) within a range of about two millimeters to about three millimeters, although the present invention contemplates many different thicknesses T for guide plate 115.

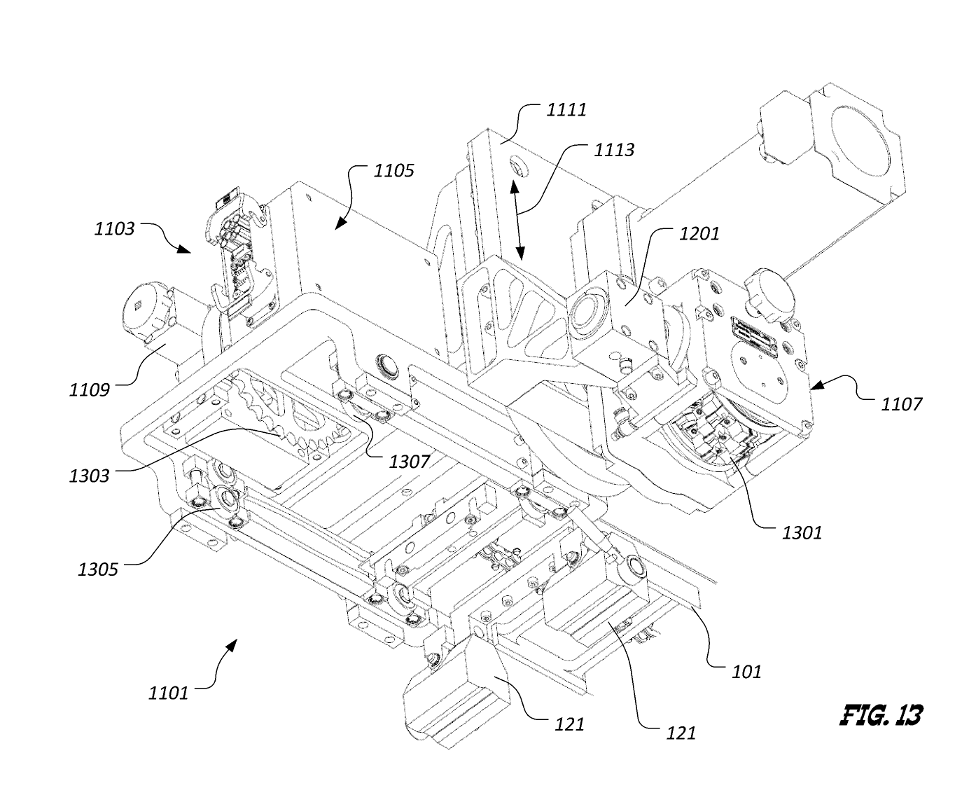

Still referring to FIGS. 1-6, base 109 of the illustrated embodiment defines a slot 117, best shown in FIGS. 5 and 6, in which drive chain 107 is received. As is discussed in greater detail herein, drive chain 107 is configured to be engaged by a sprocket, such as a sprocket 1303 shown in FIG. 13, of an apparatus, so that the apparatus can be driven along flexible track 101 by the sprocket. As best shown in FIGS. 7 and 8, drive chain 107 of the illustrated embodiment is an attachment roller chain, such as 50 Series Bent Lug Attachment Roller Chain provided by Renold Jeffrey. The present invention, however, contemplates many different gages or sizes of drive chain 107, as the gage or size of drive chain 107 is implementation specific. For example, an apparatus configured to travel along flexible track 101 may be small and lightweight or large and heavy. A small, lightweight apparatus may include a small sprocket, which requires a small-gage drive chain 107. Similarly, a large, heavy apparatus may include a large sprocket, which requires a large-gage drive chain 107. Drive chain 107 in the illustrated embodiment comprises a plurality of rollers 700 located on a neutral bending axis 145 (shown in FIGS. 1, 4 and 8) of base 109. Thus, drive chain 107 conforms in longitudinal direction 111 to flexible track 101 as flexible track 101 bends. Drive chain 107 further comprises a plurality of attachment tabs 701 (only one labeled in FIGS. 7 and 8 for clarity). Each attachment tab 701 defines an opening 703 (only one labeled in FIG. 7 for clarity) therethrough. Drive chain 107 is mounted to base 109, in the illustrated embodiment, by a plurality of fasteners 119 (only one labeled for clarity), such as a plurality of rivets. One fastener 119 extends through each opening 703 and engages base 109 to retain drive chain 107 on base 109.

While the present invention is not so limited, the illustrated embodiment of flexible track 101 is configured to be releasably attached to a structure during use. In particular, the illustrated embodiment of flexible track 101 comprises a plurality of magnetic clamps 121 attached to base 109. In the illustrated embodiment, each magnetic clamp 121 includes a switch 123 that is movable from an active or “on” position (shown in at least FIG. 1) to an inactive or “off” position, as indicated by a double-headed arrow 125. In other words, when switch 123 is in the active position, magnetic clamp 121 magnetically attracts a ferromagnetic structure proximate thereto. Conversely, when switch 123 is in the inactive position, magnetic clamp 121 provides little or no magnetic attraction for a ferromagnetic structure proximate thereto. Accordingly, when at least some of the plurality of magnetic clamps 121 are in the active state, flexible track 101 can be releasably affixed to a ferromagnetic structure (not shown). It should be noted that the present invention contemplates many, various devices incorporated therein for attaching flexible track 101 to a structure, such as vacuum cups, weld stud feet, and the like.

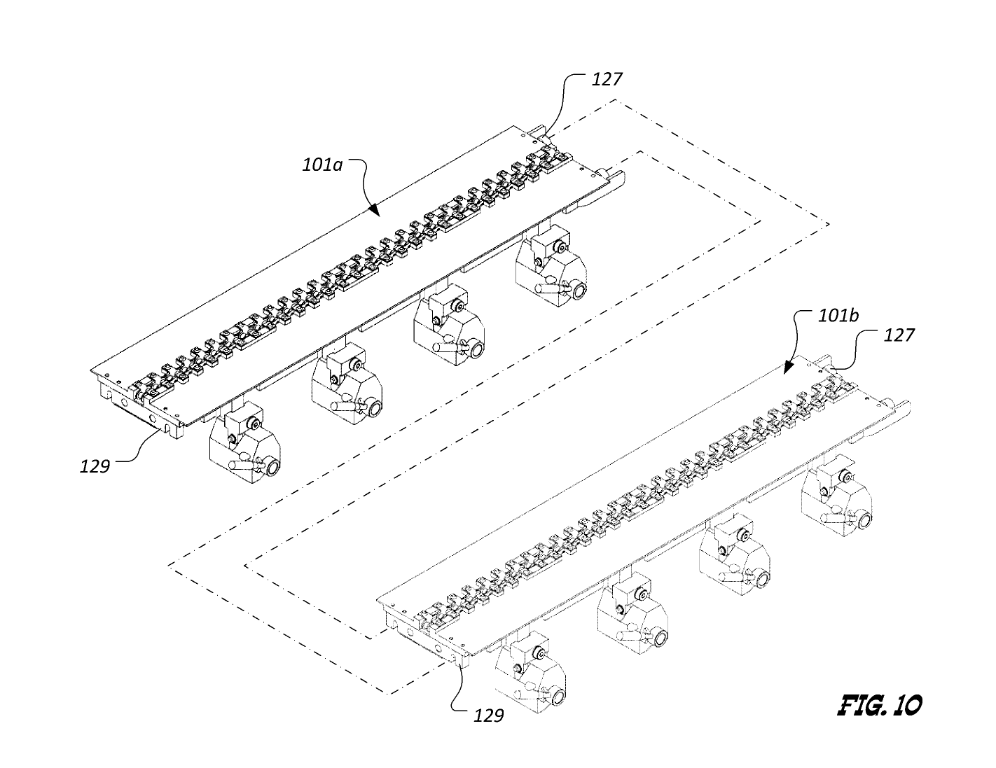

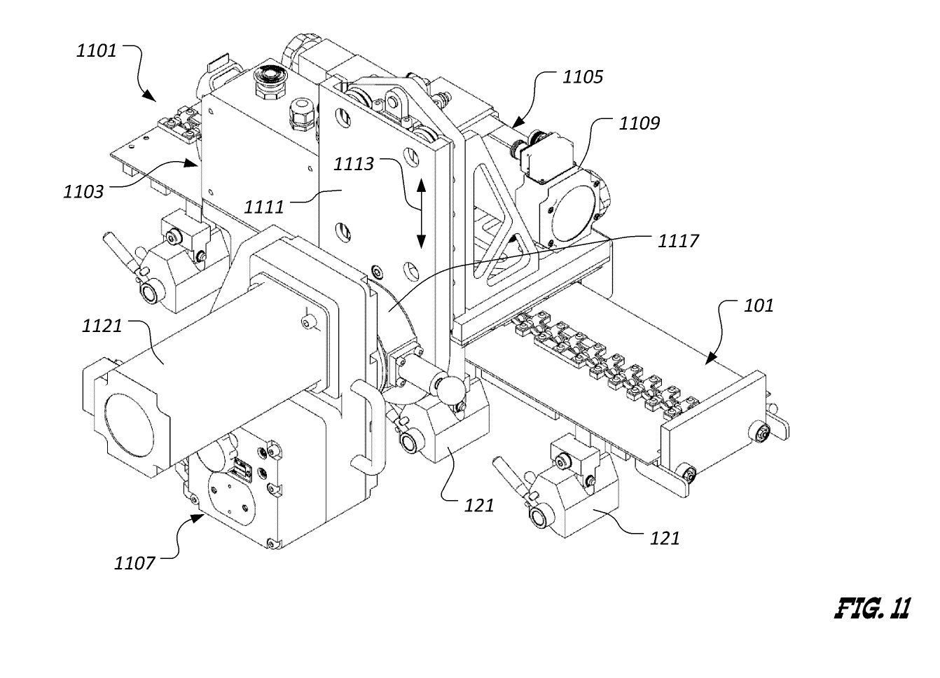

Still referring to FIGS. 1-6, the embodiment of flexible track 101 depicted therein includes a cam fitting 127 (best shown in FIGS. 1 and 5) attached to base 109 at cam end 103 and a slotted fitting 129 (best shown in FIGS. 1 and 6) attached to base 109 at slotted end 105. Cam fitting 127 and slotted fitting 129 allow adjacent flexible tracks 101 to be attached to one another, as shown in FIG. 10. Referring in particular to FIGS. 2, 3, and 5, cam fitting 127 comprises a plate 303 and a pair of cam locks 131 operably associated with plate 303. In the illustrated embodiment, each cam lock 131 comprises a cam rod 201 (first depicted in FIG. 2) and a locking handle 133. Each cam rod 201 slidably extends through plate 303 and includes a head 135 at a first end thereof. Referring to FIG. 9, each head 135 in the illustrated embodiment comprises one or more Belleville washers 901 disposed in a cup 903. Each cam rod 201, at a second end thereof, is hingedly attached to locking handle 133 and locking handle 133 is attached to base 109 through plate 303. Locking handle 133 can be positioned in an open state, as shown in FIG. 9, or in a closed state, as shown in FIGS. 1-5 and 10. When locking handle 133 in the closed state, cam rod 201 is retracted such that head 135 is spaced closer to plate 303 than when locking handle 133 is in the open state and Belleville washers 901 are compressed. Locking handle 133 is configured to provide a cam action to compress Belleville washers 901 within cup 903. Cam fitting 127 further includes a plurality of alignment pins 203 (first shown in FIG. 2 and also shown in FIGS. 3 and 5) that extend from plate 303. Cam lock 131 and the plurality of alignment pins 203 operate in concert with slotted fitting 129, as is discussed in greater detail herein, to align and attach adjacent flexible tracks 101.

Referring now in particular to FIGS. 1 and 6, the embodiment of slotted fitting 129 depicted therein defines a pair of slots 137 and a plurality of alignment bores 139 corresponding to the plurality of alignment pins 203 (shown in FIGS. 2, 3, and 5). Referring to FIGS. 1-6 and 9, cam fitting 127 and slotted fitting 129 cooperate to align and attach adjacent flexible tracks 101. To mate adjacent flexible tracks 101, a first flexible track 101 is positioned such that its cam rods 201 of cam fitting 127 extend through slots 137 of a second flexible track 101 and the plurality of alignment pins 203 of the first flexible track 101 are received in the corresponding plurality of alignment bores 139 of the second flexible track 101 while locking handles 133 are in the open position (shown in FIG. 9). It should be noted that the first flexible track 101 is labeled 101a in FIG. 10, while the second flexible track 101 is labeled 101b in FIG. 10. Once the first flexible track 101 (101a in FIG. 10) is aligned with the second flexible track 101 (101b in FIG. 10), locking handles 133 of the first flexible track 101 (101a in FIG. 10) are moved to the closed position, which urges heads 135 of cam rods 201 against an inner surface 305 (shown in FIG. 3) of slotted fitting 129 of the second flexible track 101 (101b in FIG. 10) due to the cam action provided by locking handles 133. After heads 135 contact inner surface 305 of slotted fitting, the corresponding cam rods 201 move with respect to the respective cups 903, thus compressing Belleville washers 901 (each shown in FIG. 9). Thus, the first flexible track 101 (101a in FIG. 10) is attached to the second flexible track 101 (101b in FIG. 10) by clamping. Belleville washers 901 provide a generally constant clamping force to be applied by cam fitting 127 onto slotted fitting 129. In embodiments wherein a plurality of Belleville washers 901 are used in each cup 903, placing Belleville washers 901 in a series configuration produces a large deflection range with a near constant force output. When the first flexible track 101 (101a in FIG. 10) is coupled with the second flexible track 101 (101b in FIG. 10), drive chain 107 of the first flexible track 101 (101a in FIG. 10) is substantially aligned with drive chain 107 of the second flexible track 101 (101b in FIG. 10).

It should be noted that, while alignment pins 203 extend from plate 303 of cam fitting 127 and alignment bores 139 are defined by slotted fitting 129, the scope of the present invention is not so limited. Rather, in an alternative embodiment, alignment pins 203 may extend from slotted fitting 129 and alignment bores 139 may be defined by plate 303 of cam fitting 127.

As noted herein, a system incorporating a flexible track, such as flexible track 101, comprises the flexible track and an apparatus for performing an operation on a workpiece, the apparatus comprising a drive sprocket engaged with a drive chain, such as drive chain 107, of the flexible track. Any desired, suitable apparatus for performing an operation on a workpiece may be operably associated with the flexible track to form a system of the present invention. For example, FIGS. 11-13 depict a system 1101 comprising an apparatus 1103 configured to move along flexible track 101. In the illustrated embodiment, apparatus 1103 comprises a carriage 1105 and a process head 1107 coupled with carriage 1105. In the illustrated embodiment, process head 1107 is a weld shaving head. For clarity, apparatus 1103 is, at times, referred to herein as weld shaver 1103 and process head 1107 is, at times, referred to herein as weld shaving head 1107. Such references, however, do not limit the scope of the present invention. Rather, apparatus 1103 may be any apparatus configured to move along flexible track 101.

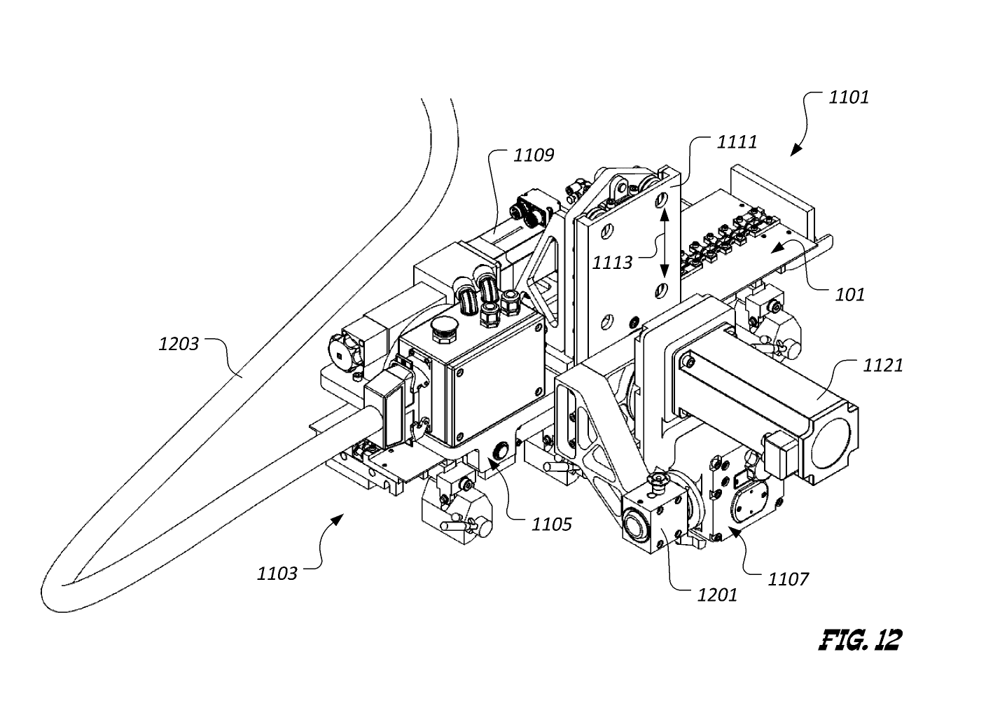

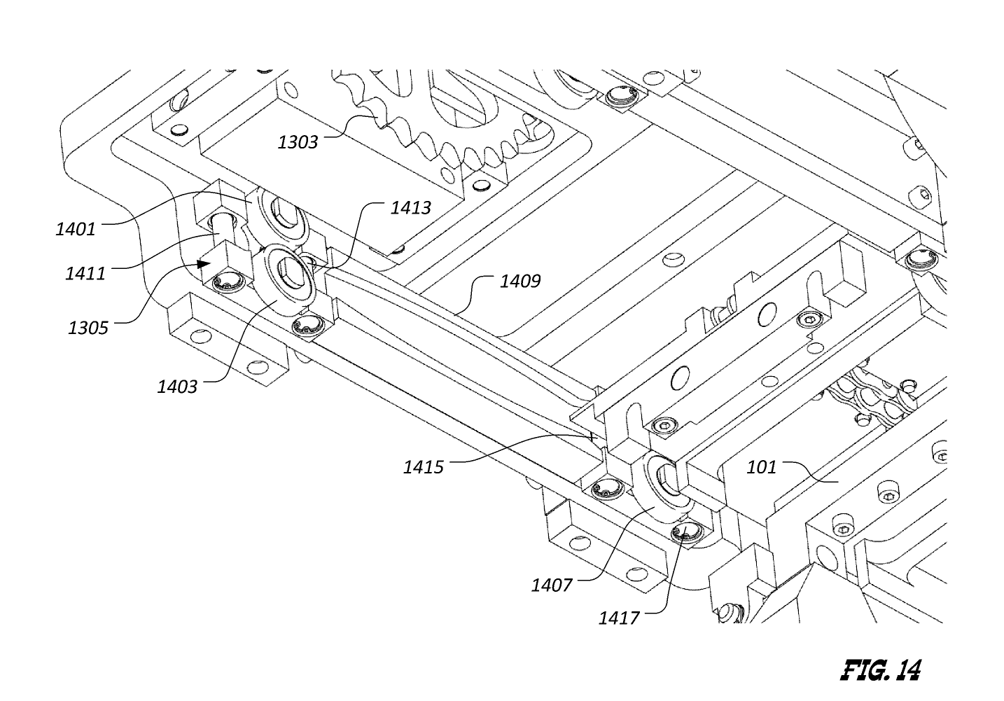

Referring in particular to FIG. 13, carriage 1105 comprises sprocket 1303 driven by a motor and gear box 1109 (shown in FIGS. 11 and 12). Preferably, the gear box of motor and gear box 1109 is a non-back drivable gear box to substantially hold carriage 1105 stationary in any orientation when power is removed from motor and gear box 1109. Motor and gear box 1109 may also include a brake in certain embodiments. Sprocket 1303 engages drive chain 107 to propel weld shaver 1103 along flexible track 101 when sprocket 1303 is driven by motor and gear box 1109. Carriage 1105 further comprises a first track guide assembly 1305 and a second track guide assembly 1307 for guiding carriage 1105 along flexible track 101. In the illustrated embodiment, first track guide assembly 1305 mirrors second track guide assembly 1307. In the illustrated embodiment, track guide assemblies 1305 and 1307 include common elements; accordingly, the description herein of first track guide assembly 1305 applies equally to second track guide assembly 1307. As best shown in FIG. 14, which is an enlarged view of a portion of the view of FIG. 13, first track guide assembly 1305 comprises an upper, front guide wheel 1401 and a lower, front guide wheel 1403, as well as an upper, rear guide wheel (corresponding to upper, front guide wheel 1401) and a lower, rear guide wheel 1407. When in use with flexible track 101, upper, front guide wheel 1401 and the upper, rear guide wheel of first track guide assembly traverse in contact with an upper side of guide plate 115 of base 109, such as in an area 142a, shown as a hatched area in FIG. 1. The upper, front guide wheel and upper, rear guide wheel of second track guide assembly 1307 traverse in contact with the upper side of guide plate 115 of base 109, such as in an area 142b, also shown as a hatched area in FIG. 1. Similarly, lower, front guide wheel 1403 and lower, rear guide wheel 1407 are traverse in contact with a lower side of guide plate 115 of base 109, such as in an area 307a, shown as a hatched area in FIG. 3. The lower, front guide wheel and lower, rear guide wheel of second track guide assembly 1307 traverse in contact with the lower side of guide plate 115 of base 109, such as in an area 307b, also shown as a hatched area in FIG. 3. A track guide 1409 is disposed between front guide wheels 1401 and 1403 and the rear guide wheels, i.e., the upper, rear guide wheel and lower rear guide wheel 1407. First track assembly 1305 further comprises front guide rollers 1411 and 1413, as well as rear guide rollers 1415 and 1417. When in use, an edge 141 (shown in FIG. 1) at least intermittently rides against guide rollers 1411, 1413, 1415, and 1417. An edge 143 (shown in FIG. 1) at least intermittently rides against the guide rollers, corresponding to guide rollers 1411, 1413, 1415, and 1417, of second track assembly 1307.

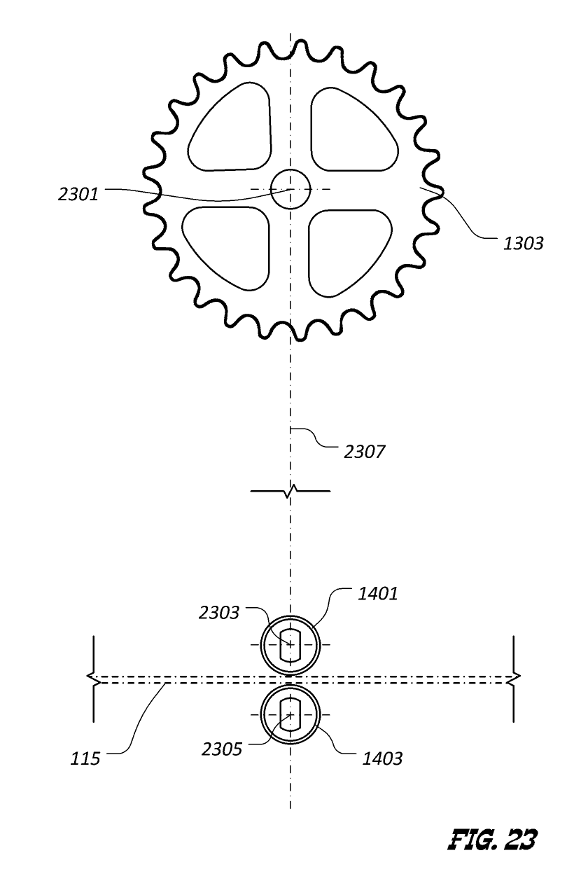

In the illustrated embodiment, as best shown in FIG. 23, a rotational axis 2301 of sprocket 1303 is aligned, as represented by a line 2307, with a rotational axis 2303 of upper, front guide wheel 1401 and a rotational axis 2305 of lower, front guide wheel 1403 of first track guide assembly 1305, as well as being aligned with the rotational axis of the upper, front guide wheel and lower front guide wheel of second track guide assembly 1307, such that sprocket 1303 remains at fixed distances from upper, front guide wheel 1401 and lower, front guide wheel 1403 when flexible track 101 (shown at least in FIG. 1) is bent or conforms to a structure to which flexible track 101 is attached. Note that guide plate 115 of flexible track 101 is shown in phantom in FIG. 23.

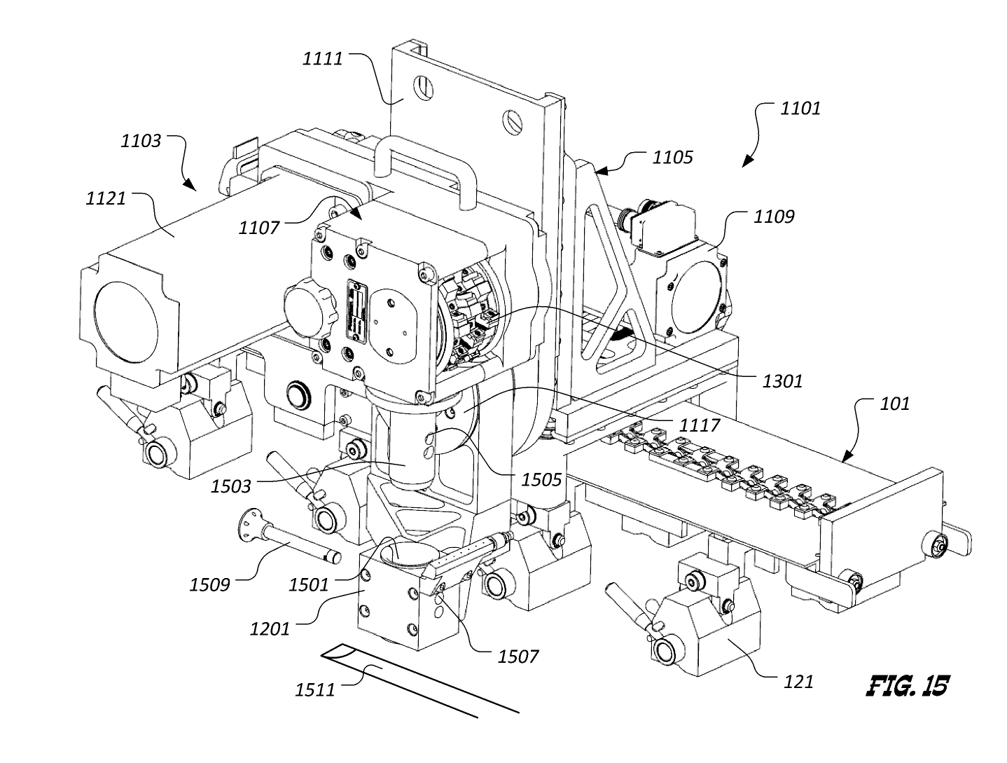

Referring now in particular to FIGS. 11, 12, and 15, carriage 1105 in the illustrated embodiment further comprises a slide 1111 that provides movement relative to carriage 1105 and, thus, relative to flexible track 101 when weld shaver 1103 is operatively associated with flexible track 101 generally in directions corresponding to a double-headed arrow 1113. In some embodiments, slide 1111 is controlled using a method for applying constant force with nonlinear feedback control, as described in U.S. Pat. No. 5,448,146 to Erlbacher, which is incorporated herein by reference for all purposes. A releasable mount 1201 (best shown in FIG. 15) is coupled with slide 1111 via a pivot fitting 1117 (best shown in FIG. 11). Weld shaver head 1107 is coupled with releasable mount 1201. Pivot fitting 1117 allows releasable mount 1201 and, thus, weld shaver head 1107, to be pivoted with respect to slide 1111 for maintenance, replacement of weld shaver head 1107, and the like. FIG. 15 depicts pivot fitting 1117 in a non-operational position, e.g., for maintenance, etc., while FIGS. 11 and 12 depict pivot fitting 1117 in an operational position.

FIG. 15 illustrates weld shaver head 1107 being coupled with releasable mount 1201. In the illustrated embodiment, releasable mount 1201 defines a bore 1501 into which an attachment shaft 1503 of weld shaver head 1107 is received. Attachment shaft 1503 defines a passageway 1505 and releasable mount 1201 defines a corresponding passageway 1507 through which an attachment pin 1509 is disposed to retain weld shaver head 1107 on releasable mount 1201. The present invention, however, contemplates other mechanisms to attach weld shaver head 1107 to releasable mount 1201.

Referring again to FIG. 13, weld shaver head 1107 comprises a cutter assembly 1301 and a motor 1121 for rotating cutter assembly 1301. When in use and driven by motor 1121, cutter assembly 1301 removes material from a workpiece, such as a weld bead 1511, shown in FIG. 15.

While process head 1107 has been described herein as being a weld shaver head, the scope of the present invention is not so limited. Rather, one of ordinary skill in the art will appreciate, having the benefit of this disclosure, that many, various heads capable of performing innumerable, diverse processes may be operably associated with carriage 1105, in place of weld shaver head 1107. Such a process head may perform one or more functions such as weld joint preparation, for example weld joint cutting, grinding, gouging, or the like; inspection, for example ultrasonic inspection, machine vision inspection, magnetic particle inspection, or the like; drilling, countersinking, or the like; welding; beveling, for example beveling plate edges; sanding, for example sanding with coated abrasives; or other such functions.

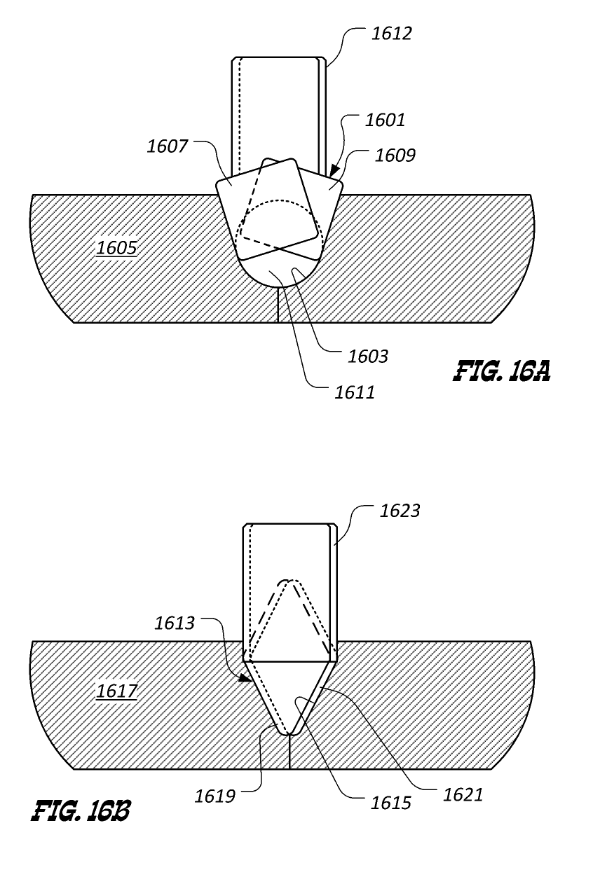

For example, process head 1107 may be a weld joint gouging head. In such an implementation, the weld joint gouging head includes, for example, a cutter assembly, corresponding to cutter assembly 1301, comprising one or more cutter groups that generate a groove along a joint in a structure to be welded. FIGS. 16A and 16B depict exemplary embodiments of such cutter groups and grooves produced by the cutter groups. In the embodiment of FIG. 16A, a cutter group 1601, when operated, generates a groove 1603 in a structure 1605. Cutter group 1601 comprises a first generally rectangular cutter 1607, a second generally rectangular cutter 1609, and a generally round cutter 1611. Cutters 1607, 1609, and 1611 are held by a cutter hub 1612. The present invention contemplates innumerable configurations of cutters and cutter groups to generate corresponding innumerable configurations of grooves. For example, FIG. 16B depicts a cutter group 1613 that, when operated, generates a groove 1615 in a structure 1617. Cutter group 1613 comprises a first generally diamond-shaped cutter 1619, and a second generally diamond-shaped cutter 1621. Cutters 1619 and 1621 are held by a cutter hub 1623.

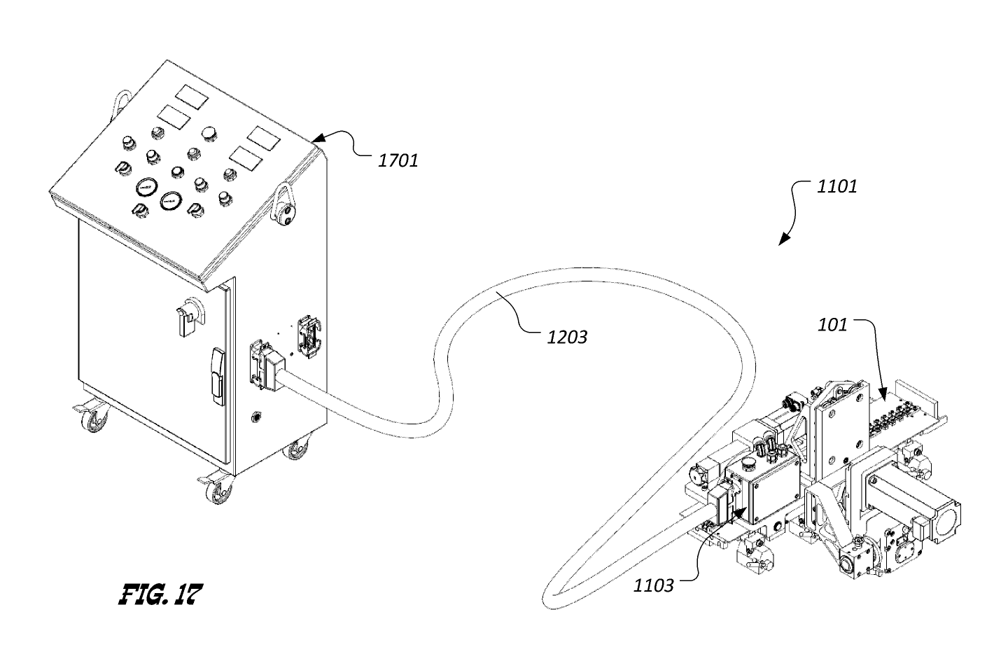

In some embodiments, system 1101 comprises apparatus 1103 and flexible track 101. In other embodiments, for example, as shown in FIG. 17, system 1101 comprises apparatus 1103, flexible track 101, and a controller 1701 for controlling apparatus 1103. In the illustrated embodiment, controller 1701 is coupled with apparatus 1103 by an umbilical 1203 (first shown in FIG. 12).

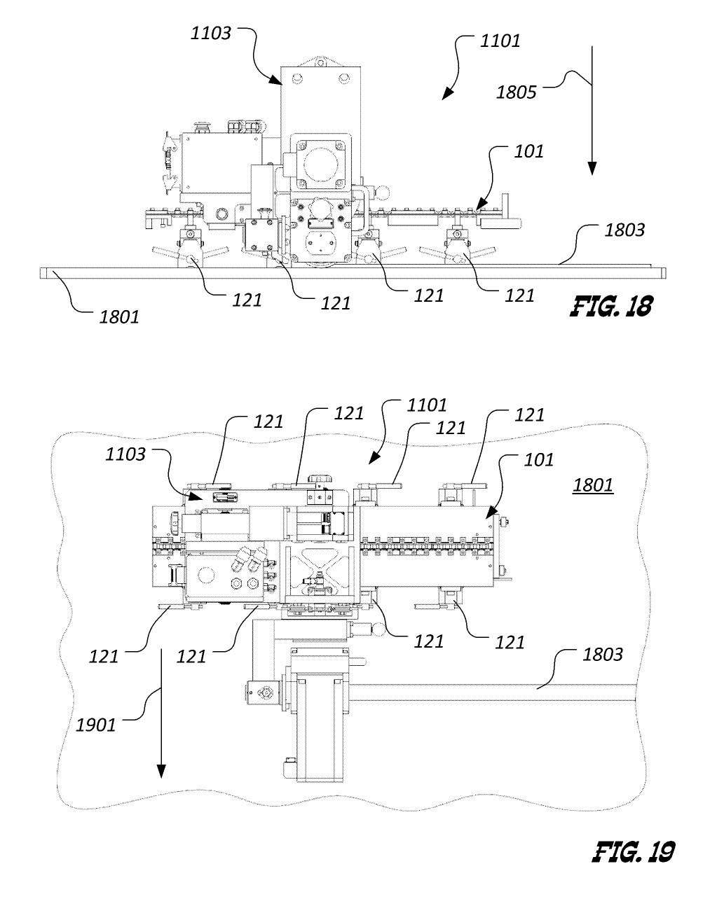

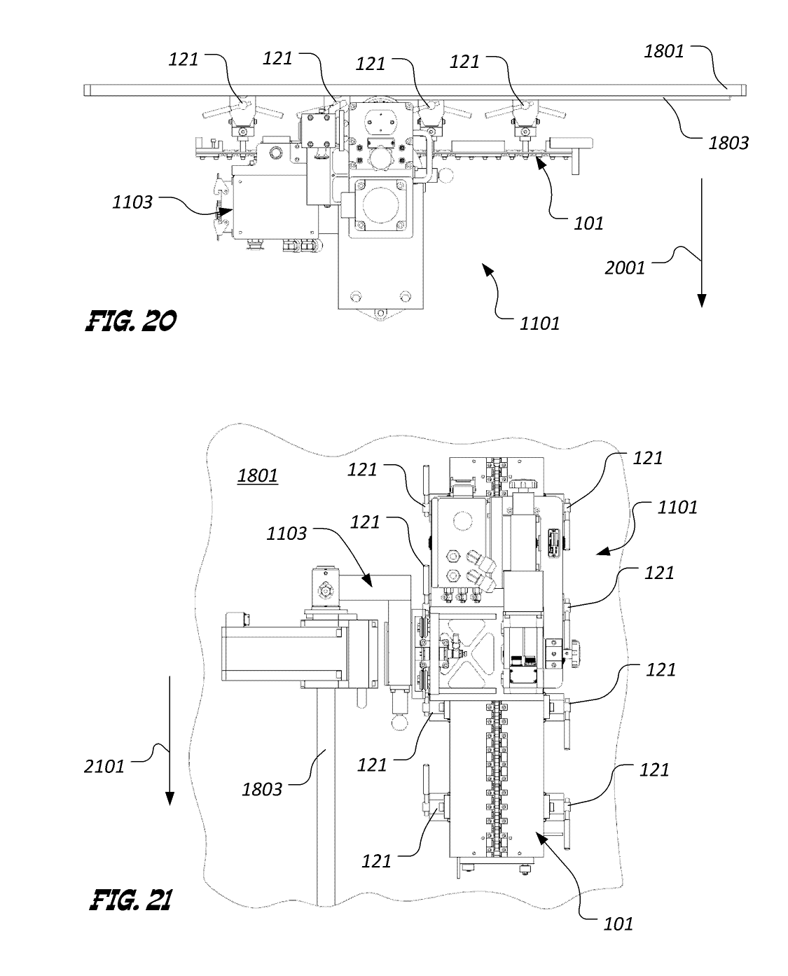

The illustrated embodiment of flexible track 101 and, thus, system 1101 may be used in any desired orientation. FIGS. 18-21 depict exemplary orientations in which system 1101 may be used. In each of FIGS. 18-21, flexible track 101 is attached via magnetic clamps 121 or other such attachment devices to a structure 1801 having a weld bead 1803 to be removed by system 1101. FIG. 18 depicts system 1101 in a flat or “downhand” orientation, wherein an arrow 1805 generally indicates a down direction. FIG. 19 depicts system 1101 in a horizontal orientation, wherein an arrow 1901 generally indicates a down direction. FIG. 20 depicts system 1101 in an overhead orientation, wherein an arrow 2001 generally indicates a down direction. FIG. 21 depicts system 1101 in a vertical orientation, wherein an arrow 2101 generally indicates a down direction.

As discussed herein, flexible track 101 is configured to generally conform to a curved surface. FIG. 22 depicts exemplary implementations of flexible track 101. As shown in FIG. 22, a first flexible track 2201, which corresponds to two joined sections of flexible track 101, is disposed on an internal or concave surface 2203 of a structure 2205. A second flexible track 2207, which corresponds to two joined sections of flexible track 101, is disposed on an external or convex surface 2209 of structure 2205. In the illustrated implementation, flexible tracks 101, 2201, and 2207 are configured to generally conform to a curved surface, such as surfaces 2203 and 2209, exhibiting a radius generally equal to or greater than about one meter. The present invention, however, contemplates flexible tracks, such as flexible tracks 101, 2201, and 2207, that are configured to generally conform to surfaces exhibiting other radii.

The present invention provides many advantages, including, but not limited to, (1) providing a way to perform operations, especially operations that impart high forces, such as high torsional or twisting loads, on very large structures and workpieces; (2) providing a way to perform operations on curved surfaces of very large, structures and workpieces; (3) providing a flexible track, along which an apparatus for performing an operation on a workpiece may travel over long distances, such as 30 meters or longer, that generally conforms to a curved surface of workpiece; and (4) providing a way to alleviate the human and monetary costs associated with performing manual operations on workpieces, such as very large structures.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below. It is apparent that an invention with significant advantages has been described and illustrated. Although the present invention is shown in a limited number of forms, it is not limited to just these forms, but is amenable to various changes and modifications without departing from the spirit thereof.

1. A flexible track, comprising:
a base configured to be generally flexible along a neutral bending axis of the flexible track and generally rigid in a torsional direction, the torsional direction being generally rotated about the neutral bending axis; and
a drive chain mounted to the base aligned generally with the neutral bending axis.

2. The flexible track of claim 1, further comprising at least one device, coupled with the base, for releasably attaching the track to a structure.

3. The flexible track of claim 2, wherein the at least one device for releasably attaching the track to a structure comprises:
one of a magnetic clamp, a vacuum cup, and a weld stud foot.

4. The flexible track of claim 1, wherein the base comprises:
a guide plate; and
one or more stiffeners extending from the guide plate.

5. The flexible track of claim 1, wherein the base defines a slot in which the drive chain is mounted.

6. The flexible track of claim 1, further comprising:
a cam fitting disposed at a first end of the base; and
a slotted fitting disposed at a second end of the base.

7. The flexible track of claim 6, further comprising:
a second base corresponding to the base;
a second drive chain corresponding to the drive chain; and
one of a second cam fitting disposed at a first end of the second base and a second slotted fitting disposed at a second end of the second base;
wherein either the second cam fitting is coupled with the slotted fitting or the second slotted fitting is coupled with the cam fitting to couple the base with the second base.

8. The flexible track of claim 6:
wherein the cam fitting comprises:
a plate; and
a pair of cam locks, each cam lock comprising:
a cam rod slidably extending through the plate, the cam rod including a head; and
a locking handle operatively associated with the cam rod and the base, such that the cam rod moves with respect to the plate when the locking handle is moved; and
wherein the slotted fitting comprises:
a plate defining a pair of slots corresponding to the pair of cam locks.

9. A system, comprising:
a flexible track, comprising:
a base configured to be generally flexible along the neutral bending axis of the flexible track and generally rigid in a torsional direction, the torsional direction being generally rotated about the neutral bending axis; and
a drive chain mounted to the base aligned generally with the neutral bending axis; and
an apparatus, comprising:
a drive sprocket engaged with the drive chain; and
a motor and gear box operably associated with the drive sprocket.

10. The system of claim 9, further comprising a device, coupled with the base, for releasably attaching the track to a structure.

11. The system of claim 10, wherein the device for releasably attaching the track to a structure comprises:
a magnetic clamp.

12. The system of claim 9, wherein the base comprises:
a guide plate; and
one or more stiffeners extending from the guide plate.

13. The system of claim 9, wherein the base defines a slot in which the drive chain is mounted.

14. The system of claim 9, further comprising:
a cam fitting disposed at a first end of the base; and
a slotted fitting disposed at a second end of the base.

15. The system of claim 14, further comprising:
a second base corresponding to the base;
a second drive chain corresponding to the drive chain; and
one of a second cam fitting disposed at a first end of the second base and a second slotted fitting disposed at a second end of the second base;
wherein either the second cam fitting is coupled with the slotted fitting or the second slotted fitting is coupled with the cam fitting to couple the base with the second base.

16. The system of claim 14:
wherein the cam fitting comprises:
a plate; and
a pair of cam locks, each cam lock comprising:
a cam rod slidably extending through the plate, the cam rod including a head; and
a locking handle operatively associated with the cam rod and the base, such that the cam rod moves with respect to the plate when the locking handle is moved; and
wherein the slotted fitting comprises:
a plate defining a pair of slots corresponding to the pair of cam locks.

17. The system of claim 9, wherein the apparatus comprises:
a carriage; and
a process head coupled with the carriage.

18. The system of claim 17, wherein the process head is removably coupled with the carriage.

19. The system of claim 17, wherein the process head is configured for at least one of weld joint preparation, weld joint cutting, weld joint grinding, weld joint gouging, inspection, ultrasonic inspection, machine vision inspection, magnetic particle inspection, drilling, countersinking, welding, beveling, beveling plate edges, sanding, and sanding with coated abrasives;.

20. The system of claim 9, further comprising:
a controller coupled with the apparatus for operating the apparatus.
